(19) United States
(12) Patent Application Publication
(10) Pub. No.: US 2026/0289838 A1
(43) Pub. Date: Sep. 24, 2026

(54) DATA PROCESSING METHOD, HEAT MAP GENERATION METHOD AND DEVICE

(71) Applicant: BOE TECHNOLOGY GROUP CO., LTD., Beijing (CN)

(72) Inventor: Yaxing Wang, Beijing (CN)

(21) Appl. No.: 19/476,163

(22) PCT Filed: Apr. 16, 2024
(86) PCT No.: PCT/CN2024/088016

§ 371 Date: Oct. 16, 2025

(30) Foreign Application Priority Data
May 31, 2023 (CN) 202310639415.2

(51) Int. Cl. G06T 11/26; G06T 7/70; G06T 11/10

(52) U.S. Cl. CPC G06T 11/26; G06T 7/70; G06T 11/10; G06T 2207/20072

(57) ABSTRACT

Data processing method, heat map generation method and device are provided. The data processing method includes: receiving first physical coordinates of object(s) in an image in a scene coordinate system and calibration coordinates for a scene view, where the calibration coordinates represent size of view area corresponding to a scene in the scene view; dividing the scene in the scene coordinate system to obtain grids; allocating the first physical coordinate of object(s) to a corresponding grid based on the first physical coordinates of object(s) in the scene coordinate system; fusing the first physical coordinates of the object contained in each grid to obtain fused physical coordinates; generating initial hotspot data in an image coordinate system according to the calibration coordinates, actual width and height of the scene, and the fused physical coordinates; and transmitting the initial hotspot data to the terminal to generate a heat map within the scene.

### CROSS REFERENCE TO RELATED APPLICATION(S)

This application is a National Stage Application of International Application No. PCT/CN2024/088016, filed on Apr. 16, 2024, entitled “DATA PROCESSING METHOD, HEAT MAP GENERATION METHOD AND DEVICE”, which claims priority to Chinese Patent Application No. 202310639415.2 filed on May 31, 2023, which is incorporated herein by reference in its entirety.

### TECHNICAL FIELD

The present disclosure relates to a technical field of computer, and in particular to a data processing method and device, a heat map generation method and device, an image processing method and device, an electronic apparatus, a storage medium, and a computer program product.

### BACKGROUND

A heat map may highlight the degree of interest of an object to each area of the scene, and clearly and intuitively display the characteristics of each area. In the scene such as smart city or smart retail, a heat map may be used to indicate the degree of attention of the object to each area, thereby providing a basis for adjusting the layout of the scene.

### SUMMARY

The present disclosure provides a data processing method and device, a heat map generation method and device, an image processing method and device, an electronic apparatus, a storage medium, and a computer program product.

According to one aspect of the present disclosure, a data processing method is provided. The method includes: receiving first physical coordinates of at least one object in an image in a scene coordinate system from an image collection device and calibration coordinates for a scene view from a terminal, in which the calibration coordinates represent a size of a view area corresponding to a scene in the scene view; dividing the scene in the scene coordinate system to obtain a plurality of grids; for each of the plurality of grids, respectively allocating the first physical coordinate of the at least one object to a corresponding grid based on the first physical coordinates of the at least one object in the scene coordinate system; performing fusion processing on the first physical coordinates of the object contained in each grid to obtain fused physical coordinates; generating initial hotspot data that is based on an image coordinate system according to the calibration coordinates for the scene view, an actual width and an actual height of the scene, and the fused physical coordinates; and transmitting the initial hotspot data to the terminal, so that the terminal generates a heat map within the scene based on the initial hotspot data.

According to the embodiments of the present disclosure, the generating initial hotspot data that is based on an image coordinate system according to the calibration coordinates for the scene view, an actual width and an actual height of the scene, and the fused physical coordinates includes: converting the fused physical coordinates into initial fused pixel coordinates that is based on the image coordinate system according to the calibration coordinates for the scene view and the actual width and the actual height of the scene; determining an initial display radius of the fused pixel coordinates according to the calibration coordinates for the scene view and the actual width and the actual height of the scene; and determining the initial fused pixel coordinates and the initial display radius as the initial hotspot data.

According to the embodiments of the present disclosure, the first physical coordinates of the at least one object in the image in the scene coordinate system include first physical coordinates of objects contained in images respectively collected at a plurality of image collection moments in the scene coordinate system; and the respectively allocating the first physical coordinate of the at least one object to a corresponding grid based on the first physical coordinates of the at least one object in the scene coordinate system includes: determining a quantity of the first physical coordinates of the objects contained in the images respectively collected at the plurality of image collection moments; and in response to determining that the quantity exceeds a preset threshold, allocating the first physical coordinates of the objects contained in the image collected at each image collection moment to corresponding grids to obtain the first physical coordinates of the object contained in each grid at each image collection moment.

According to the embodiments of the present disclosure, the performing fusion processing on the first physical coordinates of the object contained in each grid to obtain fused physical coordinates includes: performing fusion processing on the first physical coordinates of the object contained in each grid at each image collection moment to obtain initial fused physical coordinates in each grid at each image collection moment; and performing fusion on the initial fused physical coordinates in each grid at the plurality of image collection moments to obtain the fused physical coordinates.

According to another aspect of the present disclosure, a heat map generation method is provided. The method includes: transmitting calibration coordinates for a scene view to a server side, in which the calibration coordinates represent a size of a view area corresponding to a scene in the scene view; in response to receiving initial hotspot data from the server side, acquiring a first height and a first width of the scene view at a first page resolution, and acquiring an original height and an original width of the scene view at an original page resolution; converting the initial hotspot data into target hotspot data at the first page resolution based on the first height, the first width, the original height, and the original width; and generating a heat map within the scene based on the target hotspot data.

According to the embodiments of the present disclosure, the initial hotspot data includes initial fused pixel coordinates and an initial display radius; and the converting the initial hotspot data into target hotspot data at the first page resolution based on the first height, the first width, the original height, and the original width includes: determining a first width ratio based on the first width and the original width; determining a first height ratio based on the first height and the original height; converting the initial fused pixel coordinates into the target pixel coordinates according to the first width ratio and the first height ratio; converting the initial display radius into a target display radius according to the first width ratio; and determining the target hotspot data according to the target pixel coordinates and the target display radius.

According to the embodiments of the present disclosure, the heat map generation method further includes: acquiring a second height and a second width of the scene view at a second page resolution; receiving configuration information for origin coordinates of the scene view; and calibrating a view area in the scene view using the second height, the second width, the original height and the original width based on the origin coordinates of the scene view to obtain calibration coordinates for the scene view.

According to the embodiments of the present disclosure, the calibrating a view area in the scene view using the second height, the second width, the original height and the original width to obtain calibration coordinates for the scene view includes: receiving a calibration operation for the view area to determine calibration position information for the viewing area; determining a second height ratio according to the second height and the original height; determining a second width ratio according to the second width and the original width; and determining the calibration coordinates based on the second height ratio, the second width ratio, and the calibration position information for the view area.

According to another aspect of the present disclosure, an image processing method is provided. The method includes: acquiring an image collected at each image collection moment; determining pixel coordinates of at least one object in the image in an image coordinate system; converting the pixel coordinates of the at least one object in the image coordinate system into second physical coordinates in a scene coordinate system relative to origin coordinates of the image coordinate system; correcting the second physical coordinates based on a correspondence between the origin coordinates of the image coordinate system and origin coordinates of the scene coordinate system to obtain first physical coordinates of the at least one object in the scene coordinate system; and transmitting the first physical coordinates of the at least one object in the scene coordinate system to a server side.

According to the embodiments of the present disclosure, the correcting the second physical coordinates based on a correspondence between the origin coordinates of the image coordinate system and origin coordinates of the scene coordinate system to obtain first physical coordinates of the at least one object in the scene coordinate system includes: determining a coordinate correction value of the origin coordinates of the image coordinate system relative to the origin coordinates of the scene coordinate system in the scene coordinate system based on the correspondence between the origin coordinates of the image coordinate system and the origin coordinates of the scene coordinate system; and correcting the second physical coordinates based on the coordinate correction value to obtain the first physical coordinates of the at least one object in the scene coordinate system.

According to another aspect of the present disclosure, a data processing device is provided. The device includes: a first receiving module configured to receive first physical coordinates of at least one object in an image in a scene coordinate system from an image collection device and calibration coordinates for a scene view from a terminal, in which the calibration coordinates represent a size of a view area corresponding to a scene in the scene view; a division module configured to divide the scene in the scene coordinate system to obtain a plurality of grids; an allocation module configured to, for each of the plurality of grids, respectively allocate the first physical coordinate of the at least one object to a corresponding grid based on the first physical coordinates of the at least one object in the scene coordinate system; a fusion module configured to perform fusion processing on the first physical coordinates of the object contained in each grid to obtain fused physical coordinates; a first generation module configured to generate initial hotspot data that is based on an image coordinate system according to the calibration coordinates for the scene view, an actual width and an actual height of the scene, and the fused physical coordinates; and a first transmitting module configured to transmit the initial hotspot data to the terminal, so that the terminal generates a heat map within the scene based on the initial hotspot data.

According to the embodiments of the present disclosure, the first generation module includes: a first conversion unit configured to convert the fused physical coordinates into initial fused pixel coordinates that is based on the image coordinate system according to the calibration coordinates for the scene view and the actual width and the actual height of the scene; a first determination unit configured to determine an initial display radius of the fused pixel coordinates according to the calibration coordinates for the scene view and the actual width and the actual height of the scene; and a second determination unit configured to determine the initial fused pixel coordinates and the initial display radius as the initial hotspot data.

According to the embodiments of the present disclosure, the first physical coordinates of the at least one object in the image in the scene coordinate system include first physical coordinates of objects contained in images respectively collected at a plurality of image collection moments in the scene coordinate system; and the allocation module includes: a third determination unit configured to determine a quantity of the first physical coordinates of the objects contained in the images respectively collected at the plurality of image collection moments; and an allocation unit configured to, in response to determining that the quantity exceeds a preset threshold, allocate the first physical coordinates of the objects contained in the image collected at each image collection moment to corresponding grids to obtain the first physical coordinates of the object contained in each grid at each image collection moment.

According to the embodiments of the present disclosure, the fusion module includes: a first fusion unit configured to perform fusion processing on the first physical coordinates of the object contained in each grid at each image collection moment to obtain initial fused physical coordinates in each grid at each image collection moment; and a second fusion unit configured to perform fusion on the initial fused physical coordinates in each grid at the plurality of image collection moments to obtain the fused physical coordinates.

According to another aspect of the present disclosure, a heat map generation device is provided. The device includes: a second transmitting module configured to transmit calibration coordinates for a scene view to a server side, in which the calibration coordinates represent a size of a view area corresponding to a scene in the scene view; a first acquisition module configured to, in response to receiving initial hotspot data from the server side, acquire a first height and a first width of the scene view at a first page resolution and an original height and an original width of the scene view at an original page resolution; a first conversion module configured to convert the initial hotspot data into target hotspot data at the first page resolution based on the first height, the first width, the original height, and the original width; and a second generation module configured to generate a heat map within the scene based on the target hotspot data.

According to the embodiments of the present disclosure, the initial hotspot data includes initial fused pixel coordinates and an initial display radius; and the first conversion module includes: a fourth determination unit configured to determine a first width ratio based on the first width and the original width; a fifth determination unit configured to determine a first height ratio based on the first height and the original height; a second conversion unit configured to convert the initial fused pixel coordinates into the target pixel coordinates according to the first width ratio and the first height ratio; a third conversion unit configured to convert the initial display radius into a target display radius according to the first width ratio; and a sixth determination unit configured to determine the target hotspot data according to the target pixel coordinates and the target display radius.

According to the embodiments of the present disclosure, the heat map generation device further includes: a second acquisition module configured to acquire a second height and a second width of the scene view at a second page resolution; a second receiving module configured to receive configuration information for origin coordinates of the scene view; and a calibration module configured to calibrate a view area in the scene view using the second height, the second width, the original height and the original width based on the origin coordinates of the scene view to obtain calibration coordinates for the scene view.

According to the embodiments of the present disclosure, the calibration module includes: a receiving unit configured to receive a calibration operation for the view area to determine calibration position information for the viewing area; a seventh determination unit configured to determine a second height ratio according to the second height and the original height; an eighth determination unit configured to determine a second width ratio according to the second width and the original width; and a ninth determination unit configured to determine the calibration coordinates based on the second height ratio, the second width ratio, and the calibration position information for the view area.

According to another aspect of the present disclosure, an image processing device is provided. The device includes: a third acquisition module configured to acquire an image collected at each image collection moment; a determination module configured to determine pixel coordinates of at least one object in the image in an image coordinate system; a second conversion module configured to convert the pixel coordinates of the at least one object in the image coordinate system into second physical coordinates in a scene coordinate system relative to origin coordinates of the image coordinate system; a correction module configured to correct the second physical coordinates based on a correspondence between the origin coordinates of the image coordinate system and origin coordinates of the scene coordinate system to obtain first physical coordinates of the at least one object in the scene coordinate system; and a third transmitting module configured to transmit the first physical coordinates of the at least one object in the scene coordinate system to a server side.

According to the embodiments of the present disclosure, the correction module includes: a tenth determination unit configured to determine a coordinate correction value of the origin coordinates of the image coordinate system relative to the origin coordinates of the scene coordinate system in the scene coordinate system based on the correspondence between the origin coordinates of the image coordinate system and the origin coordinates of the scene coordinate system; and a correction unit configured to correct the second physical coordinates based on the coordinate correction value to obtain the first physical coordinates of the at least one object in the scene coordinate system.

According to another aspect of the present disclosure, an electronic apparatus is provided. The apparatus includes a memory and a processor, in which the memory stores instructions executable by the processor, and when executed by the processor, the instructions are configured to cause the processor to execute the method described above.

According to another aspect of the present disclosure, a non-transitory computer-readable storage medium storing computer instructions is provided, in which the computer instructions are configured to cause a computer to execute the method described above.

According to another aspect of the present disclosure, a computer program product including a computer program is provided, in which the computer program, when executed by a processor, implements the method described above.

According to another aspect of the present disclosure, a cloud server including the data processing device described above is provided.

According to another aspect of the present disclosure, a terminal including the heat map generation device described above is provided.

According to another aspect of the present disclosure, an image collection apparatus including the image processing device described above is provided.

It should be understood that the contents described in this section are neither intended to identify the key or important features of the embodiments of the present disclosure, nor are they intended to limit the scope of the present disclosure. Other features of the present disclosure will become readily understood from the following description.

### BRIEF DESCRIPTION OF THE DRAWINGS

The accompanying drawings are used to better understand the present solution and do not constitute a limitation of the present disclosure, in which:

FIG. 1 is a system architecture applicable to a data processing method and device, a heat map generation method and device, and an image processing method and device according to the embodiments of the present disclosure;

FIG. 2 is a flowchart of the data processing method according to the embodiments of the present disclosure;

FIG. 3 is a schematic diagram of determining physical coordinates of each grid according to the embodiments of the present disclosure;

FIG. 4 is a flowchart of a method for acquiring fused physical coordinates according to the embodiments of the present disclosure;

FIG. 5 is a flowchart of a heat map generation method according to the embodiments of the present disclosure;

FIG. 6 is a schematic diagram of a process for determining calibration coordinates for a scene view according to the embodiments of the present disclosure;

FIG. 7A and FIG. 7B are respectively effect diagrams of heat maps generated at different page resolutions;

FIG. 8 is a flowchart of an image processing method according to the embodiments of the present disclosure;

FIG. 9 schematically shows second physical coordinates of a plurality of objects in an image in a scene coordinate system relative to origin coordinates of an image coordinate system;

FIG. 10 is a block diagram of a data processing device according to the embodiments of the present disclosure;

FIG. 11 is a block diagram of a heat map generation device according to the embodiments of the present disclosure;

FIG. 12 is a block diagram of an image processing device according to the embodiments of the present disclosure;

FIG. 13 is a block diagram of an electronic apparatus for implementing the data processing method, the heat map generation method, and the image processing method of the embodiments of the present disclosure.

### DETAILED DESCRIPTION OF EMBODIMENTS

Exemplary embodiments of the present disclosure will be illustrated in conjunction with the accompanying drawings below, including various details of the embodiments of the present disclosure to facilitate understanding, and they should be considered as merely exemplary. Accordingly, those of ordinary skills in the art will recognize that various changes and modifications of the embodiments described herein may be made without departing from the scope and spirit of the present disclosure. Also, in the following description, descriptions of well-known functions and structures are omitted for clarity and conciseness

It should be noted that the serial numbers of the operations in the following methods are only used to represent the operations for the purpose of description, and should not be regarded as indicating the execution order of the operations. Unless explicitly stated, the method does not need to be executed in the exact order presented.

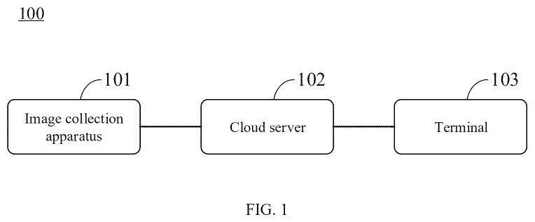

FIG. 1 is a system architecture applicable to a data processing method and device, a heat map generation method and device, and an image processing method and device according to the embodiments of the present disclosure. It should be noted that FIG. 1 is only an example of a system architecture to which the embodiments of the present disclosure may be applied to help those skilled in the art understand the technical contents of the present disclosure, but it does not mean that the embodiments of the present disclosure may not be used in other environments or scenes.

As shown in FIG. 1, a system architecture 100 may include: an image collection apparatus 101, a cloud server 102 and a terminal 103.

In the embodiments of the present disclosure, the image collection apparatus 101 may achieve image collection and data processing functions. The image collection apparatus 101 may include a plurality of image collection devices, or may be in communication connection with a plurality of image collection devices.

In the embodiments of the present disclosure, the cloud server 102 may achieve the data processing function.

In the embodiments of the present disclosure, the terminal 103 may be used to achieve image display and data processing functions. In some embodiments, the terminal 103 may also be externally connected with a display device, and the contents processed by the terminal 103 may be displayed on the display device connected externally.

In the embodiments of the present disclosure, the image collection apparatus 101 may acquire images collected at each image collection moment, convert pixel coordinates of at least one object in an image in the image coordinate system into first physical coordinates in the scene coordinate system based on a correspondence between the image coordinate system and the scene coordinate system, and then, transmit the first physical coordinates of the at least one object in the scene coordinate system to the cloud server 102. The terminal 103 may calibrate a view area corresponding to a scene in the scene view, and transmit calibration coordinates of the calibrated scene view to the cloud server 102. After receiving the first physical coordinates of the at least one object in the scene coordinate system and the calibration coordinates for the scene view, the cloud server 102 may generate initial hotspot data based on the first physical coordinates of each object and calibration coordinates, and transmit the initial hotspot data to the terminal 103. After acquiring the initial hotspot data returned by the cloud server 102, the terminal 103 may further perform conversion processing on the initial hotspot data to obtain target hotspot data that matches a current page resolution, and then generate a heat map within the scene based on the target hotspot data and display the heat map.

It should be understood that the number of the image collection apparatus 101 and the cloud server 102 in FIG. 1 are merely illustrative. Depending on implementation requirements, there may be any number of the image collection apparatus 101 and the cloud servers 102.

It should be noted that the serial numbers of the operations in the following method are merely used to indicate the operations for the convenience of description, and should not be regarded as indicating the execution order of the operations. Unless explicitly stated, the method does not need to be executed in the exact order presented.

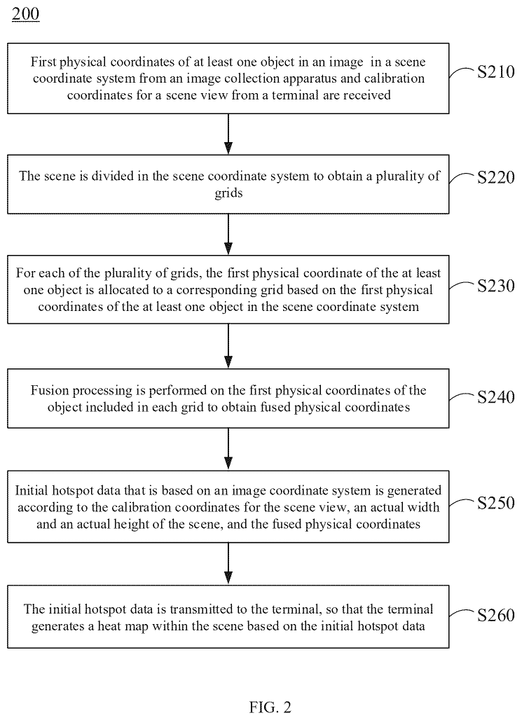

FIG. 2 is a flowchart of a data processing method according to the embodiments of the present disclosure.

As shown in FIG. 2, a data processing method 200 may include operations S210 to S260. In the embodiments of the present disclosure, the data processing method 200 may be executed by a server (such as a cloud server) as an execution subject to execute related operations in the embodiments of the present disclosure.

In operation S210, first physical coordinates of at least one object in an image in a scene coordinate system from an image collection device are received, and calibration coordinates for a scene view from a terminal are received.

In operation S220, the scene is divided in the scene coordinate system to obtain a plurality of grids.

In operation S230, for each of the plurality of grids, the first physical coordinates of the at least one object are allocated to corresponding grids based on the first physical coordinates of the at least one object in the scene coordinate system.

In operation S240, fusion processing is performed on the first physical coordinates of the objects included in each grid to obtain fused physical coordinates.

In operation S250, initial hotspot data that is based on an image coordinate system is generated according to the calibration coordinates for the scene view, an actual width and an actual height of the scene, and the fused physical coordinates.

In operation S260, the initial hotspot data is transmitted to the terminal, so that the terminal generates a heat map within the scene based on the initial hotspot data.

According to the embodiments of the present disclosure, a server side (e.g., a cloud server) may receive first physical coordinates of at least one object in an image in a scene coordinate system transmitted by an image collection apparatus, as well as calibration coordinates for a scene view from a terminal.

In the embodiments of the present disclosure, the first physical coordinates of the at least one object in the image in the scene coordinate system are obtained by collecting images of objects in a scene at corresponding moments at a certain time interval by the image collection apparatus, and performing conversion based on pixel coordinates of at least one object in the image in an image coordinate system. The time interval may be set according to actual needs and is not limited here.

In the embodiments of the present disclosure, the calibration coordinates for the scene view may be used to represent a size of a view area corresponding to a scene in the scene view. The area covered by the view area is the scene area where things to which each object pays attention are located.

It may be understood that the scene view may contain a noise area other than the view area. The noise area may be an area where object statistics is not needed, and this area may be set according to actual conditions. In addition, the noise area may also refer to an area that is statistically insignificant to the object. For example, when a terminal is used to display a view area, a noise area may appear around the view area due to changes in page resolution or due to page zooming, and the area covered by the noise area does not include the scene area where things to which the object pays attention are located. In view of this, an actual size of the view area in the scene view may be calibrated by obtaining the calibration coordinates for the scene view, thereby avoiding interference from the noise area and facilitating subsequent processing.

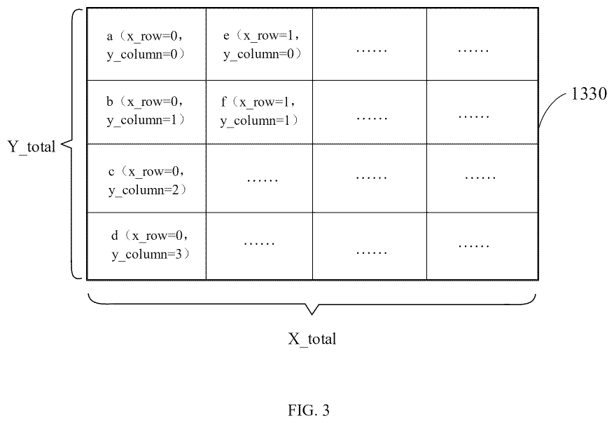

FIG. 3 is a schematic diagram of determining physical coordinates of each grid according to the embodiments of the present disclosure. An exemplary process of determining the physical coordinates of each grid is described below with reference to FIG. 3.

As shown in FIG. 3, in a scene coordinate system, an actual width X and an actual height Y of a scene 1330 may be determined based on position information of the scene 1330. Afterwards, the scene 1330 is divided according to a preset grid size grid_length to obtain a plurality of grids. The grid size may be set according to actual conditions, for example, the grid size may be 0.1 m, 0.2 m, etc.

For example, a horizontal quantity X_total of grids obtained by dividing the actual width X of the scene 1330 is determined, and a vertical quantity Y_total of grids obtained by dividing the actual height Y of the scene 1330 is determined. X_total and Y_total are respectively determined using equation (1) and equation (2) below.

$$X\_total = int ( math . ceil ( X / grid\_length ) \qquad ( 1 )$$

$$Y\_total = int ( math . ceil ( Y / grid\_length ) \qquad ( 2 )$$

where math.ceil represents rounding up to an integer. That is, if X/grid_length is an integer, then X_total is equal to (X/grid_length), otherwise X_total=X/grid_length+1.

The scene 1330 is divided based on X_total and Y_total to obtain a plurality of grids, and each grid is a minimum rectangle in FIG. 3 (exemplarily only). After a plurality of grids are obtained, the physical coordinates of each grid may be determined. For example, taking the physical coordinates of one grid as an example, the physical coordinates of this grid include four vertex coordinates, which are an upper left vertex coordinate W1, an upper right vertex coordinate W2, a lower right vertex coordinate W3 and a lower left vertex coordinate W4. The vertex coordinates are shown in equations (3) to (6).

$$W 1 = [ W1\_x , W1\_y ] = [ W\_left \_top \_x + x\_row * grid\_length , W\_left \_top \_y + y\_column * grid\_length ] \qquad ( 3 )$$

$$W 2 = [ W1\_x + grid\_length , W1\_y ] \qquad ( 4 )$$

$$W 3 = [ W1\_x + grid\_length , W1\_y + grid\_length ] \qquad ( 5 )$$

$$W 4 = [ W1\_x , W1\_y + grid\_length ] \qquad ( 6 )$$

In equations (3) to (6), W_left_top_x and W_left_top_y are respectively the horizontal and vertical coordinates of the upper left vertex of the scene. The identifications of the plurality of grids are respectively a, b, c, d, e, and f from top to bottom and from left to right. Grid a corresponds to x_row=0 and y_column=0, grid b corresponds to x_row=0 and y_column=1, and grid e corresponds to x_row=1 and y_column=0.

It may be understood that calculating the physical coordinates of each grid based on the position information of the scene area, the size of the grid, and the identification of the grid may improve the calculation efficiency and accuracy of the physical coordinates of the grid.

Next, for each of the plurality of grids, based on the first physical coordinates of the at least one object in the scene coordinate system, the first physical coordinates of the at least one object are allocated to a corresponding grid.

Afterwards, fusion processing is performed on the first physical coordinates of the objects in each grid to obtain fused physical coordinates.

For example, it is assumed that the i^{th} grid contains first physical coordinates of m objects, i=1, 2, . . . , X_total*Y_total, and m is a positive integer. The average value x̅ of the horizontal coordinates of m first physical coordinates and the average value y̅ of the vertical coordinates of m first physical coordinates in the i^{th} grid are determined. x̅ and y̅ are respectively determined by the equations (7) and (8) below.

$$\overline{x} = \frac{{\sum }_{j = 1}^{m} {x}_{j}}{m} \qquad ( 7 )$$

$$\overline{y} = \frac{{\sum }_{j = 1}^{m} {y}_{j}}{m} \qquad ( 8 )$$

In equations (7) to (8), xⱼ and yⱼ respectively represent the horizontal and vertical coordinates of the j (j=1, 2, . . . , m)^{th} first physical coordinates.

After x̅ and y̅ are determined, the fused physical coordinates (x̅, y̅) may be obtained according to x̅ and y̅.

Next, based on the correspondence between the scene coordinate system and the image coordinate system, the fused physical coordinates in the scene coordinate system may be converted into initial hotspot data in the image coordinate system according to the calibration coordinates for the scene view, the actual width and the actual height of the scene, and the fused physical coordinates. Then, the initial hotspot data is transmitted to the terminal so that the terminal generates a heat map within the scene based on the initial hotspot data.

In the technical solutions of the present disclosure, on the one hand, the actual size of the view area in the scene view is calibrated by obtaining the calibration coordinates for the scene view to avoid interference from the noise area, thereby providing a basis for improving the accuracy of the initial hotspot data. On the other hand, in the present disclosure, the physical coordinates are converted into the pixel coordinates based on the correspondence between the scene coordinate system and the image coordinate system, thereby ensuring the accuracy of the initial hotspot data and further ensuring the accuracy of the heat map.

As described above, the first physical coordinates are obtained by collecting images of objects in a scene at corresponding moments at a certain time interval by an image collection apparatus, and performing conversion based on pixel coordinates of at least one object in the image in an image coordinate system. Afterwards, the server side performs fusion processing based on the first physical coordinates of at least one object to obtain fused physical coordinates.

In some embodiments, the first physical coordinates of the at least one object in the image in the scene coordinate system may include the first physical coordinates of objects in images respectively collected at a plurality of image collection moments in the scene coordinate system. If the quantity of first physical coordinates received by the server side is too large, it may exceed the storage and computing capabilities of the server side, resulting in data overflow, thereby affecting the normal generation of initial hotspot data.

In the embodiments of the present disclosure, segmentation processing may be performed on the first physical coordinates obtained at a plurality of image collection moments according to time periods, so that the server side only needs to perform fusion processing on the first physical coordinates corresponding to each time period each time to obtain initial fused physical coordinates. Then, fusion processing is performed on the initial physical coordinates after aggregation of each segment to obtain fused physical coordinates. This may reduce the quantity of the first physical coordinates processed by the server side each time, thereby solving the problem of memory overflow at the server side and failure to generate initial hotspot data normally.

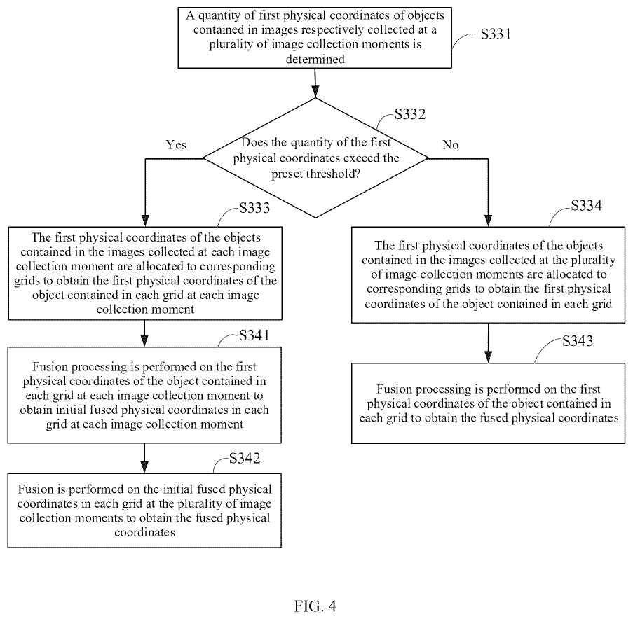

The process of segmentation processing is described below with reference to FIG. 4.

FIG. 4 is a flowchart of a method for acquiring fused physical coordinates according to the embodiments of the present disclosure.

As shown in FIG. 4, the method for acquiring fused physical coordinates may include operations S331 to S334 and operations S341 to S343.

In operation S331, a quantity of first physical coordinates of objects contained in images respectively collected at a plurality of image collection moments is determined.

In operation S332, it is determined whether the quantity of the first physical coordinates of the objects contained in the images respectively collected at the plurality of image collection moments exceeds a preset threshold. If it is determined that the quantity exceeds the preset threshold, operations S333 and S341 to S342 are executed; otherwise, operations S334 and S343 are executed.

In operation S333, the first physical coordinates of the objects contained in the image collected at each image collection moment are allocated to corresponding grids to obtain the first physical coordinates of the object contained in each grid at each image collection moment.

In operation S334, the first physical coordinates of the objects contained in the images collected at the plurality of image collection moments are allocated to corresponding grids to obtain the first physical coordinates of the object contained in each grid.

In operation S341, fusion processing is performed on the first physical coordinates of the object contained in each grid at each image collection moment to obtain initial fused physical coordinates in each grid at each image collection moment.

In operation S342, fusion is performed on the initial fused physical coordinates in each grid at the plurality of image collection moments to obtain the fused physical coordinates.

In operation S343, fusion processing is performed on the first physical coordinates of the object contained in each grid to obtain the fused physical coordinates.

According to the embodiments of the present disclosure, if it is determined that the quantity of the first physical coordinates of the objects contained in the images collected at a plurality of image collection moments exceeds a preset threshold, it indicates that the quantity of the first physical coordinates received by the server side exceeds the processing capacity of the server side. In this case, segmentation processing may be performed on the first physical coordinates obtained at the plurality of image collection moments according to time periods, so as to reduce the quantity of the first physical coordinates processed by the server side each time. If it is determined that the quantity of the first physical coordinates of the objects contained in the images collected at the plurality of image collection moments does not exceed the preset threshold, it indicates that the storage capacity and computing capacity of the server side may meet the processing requirements for the first physical coordinates. In this case, fusion processing may be directly performed on the first physical coordinates corresponding to the plurality of image collection moments to obtain fused physical coordinates.

It should be noted that, in the embodiments of the present disclosure, the preset threshold may be set according to actual conditions and is not specifically limited.

In addition, when performing segmentation processing on the first physical coordinates obtained at a plurality of image collection moments, segmentation processing may also be performed on the first physical coordinates according to preset time periods based on actual conditions, which is not limited here.

According to the embodiments of the present disclosure, the above initial hotspot data may be generated in the following manner.

For example, the fused physical coordinates may be converted to initial fused pixel coordinates based on an image coordinate system according to the calibration coordinates for the scene view as well as the actual width and the actual height of the scene.

For the convenience of description, in the following description, the view area in the scene view as a regular rectangular area is taken as an example. It should be understood that the solutions of the present disclosure are not limited thereto.

It is assumed that the calibration coordinates for the scene view include 2 vertex coordinates, which respectively correspond to an upper left vertex coordinate and a lower right vertex coordinate in the view area. Taking the upper left vertex of the scene view as the origin coordinates, in the view area, the upper left vertex coordinates may be expressed as (left_top_x, left_top_y), and the lower right vertex coordinates may be expressed as (right_bottom_x, right_bottom_y).

For example, the initial fused pixel coordinates may be determined using equations (9) to (10) below.

$$pixel\_x = \overline{x} * ( right\_bottom \_x - left\_top \_x ) / X + left\_top \_x \qquad ( 9 )$$

$$pixel\_y = \overline{y} * ( right\_bottom \_y - left\_top \_y ) / Y + left\_top \_y \qquad ( 10 )$$

In equations (9) and (10), pixel_x and pixel_y are respectively the horizontal and vertical coordinates of the initial fused pixel coordinates, x̅ and y̅ are respectively the horizontal and vertical coordinates of the fused physical coordinates, and X and Y are respectively the actual width and the actual height of the scene.

In addition, an initial display radius of the fused pixel coordinates may be determined according to the calibration coordinates for the scene view and the actual width and the actual height of the scene.

For example, the initial display radius may be determined using equation (11) below.

pixel_radius=Math.max((right_bottom_x−left_top_x)/X,(right_bottom_y−left_top_y)/Y) (11)

In equation (11), pixel_radius represents the initial display radius.

Afterwards, the initial fused pixel coordinates and the initial display radius are determined as initial hotspot data.

In the embodiments of the present disclosure, for example, the correspondence described in the above equations (9) to (11) may be used to convert the physical coordinates into pixel coordinates according to the calibration coordinates for the scene view, the actual width and the actual height of the scene, and the fused physical coordinates, thereby ensuring the accuracy of the initial hotspot data and further ensuring the accuracy of the heat map.

FIG. 5 is a flowchart of a heat map generation method according to the embodiments of the present disclosure.

As shown in FIG. 5, the heat map generation method 400 may include operations S410 to S440. In the embodiments of the present disclosure, the heat map generation method 400 may be executed by a terminal as an execution subject to execute related operations in the embodiments of the present disclosure.

In operation S410, calibration coordinates for a scene view is transmitted to a server side.

In operation S420, in response to receiving initial hotspot data from the server side, a first height and a first width of the scene view at a first page resolution are acquired, and an original height and an original width of the scene view at an original page resolution are acquired.

In operation S430, the initial hotspot data is converted into target hotspot data at the first page resolution based on the first height, the first width, the original height, and the original width.

In operation S440, a heat map within the scene is generated based on the target hotspot data.

According to the embodiments of the present disclosure, the terminal may calibrate the actual size of the view area corresponding to the scene in the scene view at a second page resolution to obtain calibration coordinates for the scene view. The second page resolution is used to indicate the page resolution corresponding to the scene view during size calibration of the scene view.

After the calibration coordinates for the scene view are determined, the terminal may transmit the calibration coordinates to the server side (such as a cloud server), so that the server side may convert the physical coordinates to pixel coordinates based on the calibration coordinates and generate initial hotspot data based on an image coordinate system.

It may be understood that during the process of generating a heat map at the terminal, a change in the page resolution will affect the display effect of the hotspot data on the heat map. For example, a change in the page resolution may cause an offset in hotspot data, resulting in that the hotspot data does not match with the current page resolution.

In order to eliminate the offset of hotspot data caused by different page resolutions, in the embodiments of the present disclosure, after receiving the initial hotspot data from the server side, the terminal may acquire a first height and a first width of the scene view at a first page resolution and acquire an original height and an original width of the scene view at an original page resolution. The first page resolution is used to indicate the page resolution corresponding to the scene view when the heat map is to be generated, i.e., the current page resolution. The original page resolution is used to indicate the page resolution corresponding to the scene view before size calibration of the scene view.

Afterwards, the terminal may convert the initial hotspot data into target hotspot data at the first page resolution based on the first height, the first width, the original height and the original width. Then, a heat map within the scene is generated based on the target hotspot data. Through the above method, the initial hotspot data may be converted into the target hotspot data that matches the current page resolution, which is conducive to displaying the page adapted to the current page resolution, thereby ensuring the accuracy of the heat map.

According to the embodiments of the present disclosure, the calibration coordinates for the scene view may be determined in the following manner.

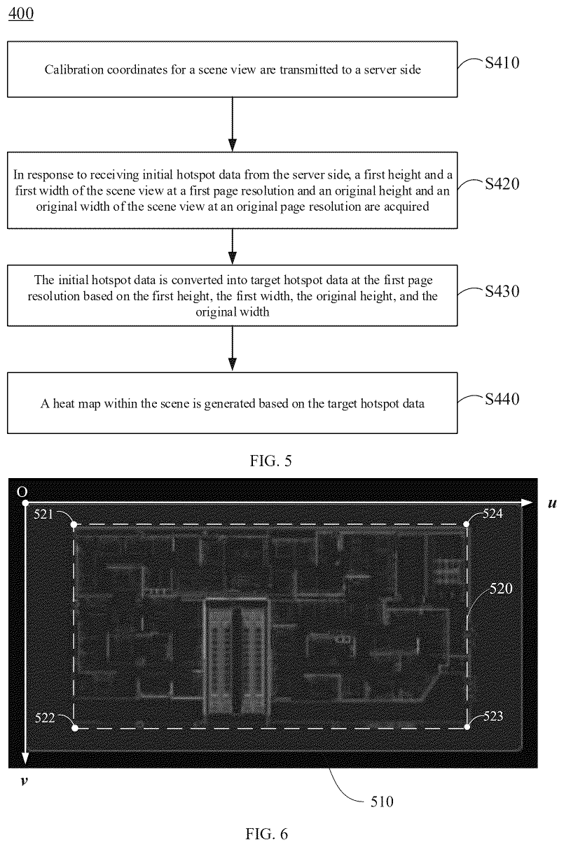

It should be noted that, for the convenience of description, the process of determining the calibration coordinates for the scene view will be illustrated by taking the view area in the scene view as a regular rectangular area as an example with reference to FIG. 6. It should be understood that the contents shown in FIG. 6 are merely exemplary and are intended to help understand the solutions of the present disclosure, but the present disclosure is not limited thereto.

FIG. 6 is a schematic diagram of a process for determining calibration coordinates for a scene view according to the embodiments of the present disclosure.

After acquiring the scene view, the terminal may scale and adjust the display ratio of the scene view on the display interface of the terminal to obtain a good display effect. As shown in FIG. 6, the scene view 510 after scaling and adjustment includes a view area 520 corresponding to the scene and a noise area (e.g., an area between the scene view 510 and the view area 520) other than the view area 520. The area covered by the noise area does not include the scene area where things to which the object pays attention are located.

In order to avoid interference from the noise area, in the embodiments of the present disclosure, the actual size of the view area 520 may be calibrated.

For example, a second height scaling_height and a second width scaling_width of the scene view 510 at the second page resolution may be acquired. The second page resolution refers to the page resolution corresponding to the scene view after the display ratio of the scene view is scaled and adjusted.

Afterwards, configuration information of origin coordinates for the scene view 510 is received. For example, according to the configuration information, it is determined that the origin coordinates for the scene view 510 are located at the upper left vertex of the scene view 510, i.e., at point O.

Next, based on the origin coordinates of the scene view 510, the view area 520 in the scene view 510 may be calibrated using the second height, the second width, the original height and the original width to obtain calibration coordinates for the scene view 510.

For example, a calibration operation for the view area 520 is received to determine calibration position information for the view area 520. For example, according to the calibration operation for the view area 520, a plurality of calibration points in the view area 520 may be determined, such as calibration point 521, calibration point 522, calibration point 523, and calibration point 524. The plurality of calibration points may be used to calibrate the actual size of the view area 520.

Each calibration point corresponds to calibration position information, and the calibration position information includes a width click_x and a height click_y corresponding to the calibration point. The width click_x and the height click_y respectively refer to the width and the height relative to the position of point O.

Next, a second height ratio may be determined according to the second height and the original height. A second width ratio is determined according to the second width and the original width. Then, the calibration coordinates are determined based on the second height ratio, the second width ratio, and the calibration position information for the view area.

For example, the calibration coordinates of each calibration point may be determined using equations (12) to (13) below.

$$result\_x = click\_x * ( resolution\_width / scaling\_width ) \qquad ( 12 )$$

$$result\_y = click\_y * ( resolution\_height / scaling\_height ) \qquad ( 13 )$$

In the above equations (12) to (13), resolution_width and resolution_height respectively represent the original width and the original height of the scene view at the original page resolution, scaling_width and scaling_height respectively represent the second width and the second height of the scene view at the second page resolution, click_x and click_y represent the calibration position information of each calibration point, and result_x and result_y respectively represent the horizontal and vertical coordinates of the calibration coordinates of each calibration point.

Based on the above equations (12) to (13), the calibration coordinates respectively corresponding to the calibration points 521 to 524 may be determined. Based on the calibration coordinates respectively corresponding to the calibration points 521 to 524, the size of the view area 520 may be determined. In this way, the size of the view area 520 is calibrated.

In some embodiments, the size of the view area 520 may also be calibrated according to the calibration coordinates respectively corresponding to the calibration points 521 and 523 or the calibration coordinates respectively corresponding to the calibration points 522 and 524. The specific selection may be made based on actual conditions.

According to the embodiments of the present disclosure, the initial hotspot data includes initial fused pixel coordinates and an initial display radius. Converting the initial hotspot data into target hotspot data at the first page resolution based on the first height, the first width, the original height, and the original width may include the following operations.

For example, a first width ratio is determined based on the first width and the original width. A first height ratio is determined based on the first height and the original height. Afterwards, the initial fused pixel coordinates are converted into target pixel coordinates according to the first width ratio and the first height ratio. The initial display radius is converted into a target display radius according to the first width ratio. Afterwards, the target hotspot data is determined according to the target pixel coordinates and the target display radius.

For example, the target pixel coordinates and the target display radius may be determined using the equations (14) to (16) below.

$$current\_pixel \_x = pixel\_x * current\_resolution \_width / resolution\_width \qquad ( 14 )$$

$$current\_pixel \_y = pixel\_y * current\_resolution \_height / resolution\_height \qquad ( 15 )$$

$$current\_pixel \_radius = pixel\_radius * current\_resolution \_width / resolution\_width \qquad ( 16 )$$

In equations (14) to (16), current_pixel_x and current_pixel_y respectively represent the horizontal and vertical coordinates of the target pixel coordinates, current_pixel_radius represents the target display radius, pixel_x and pixel_y respectively represent the horizontal and vertical coordinates of the initial fused pixel coordinates, pixel_radius represents the initial display radius, resolution_width and resolution_height respectively represent the original width and the original height of the scene view at the original page resolution, and current_resolution_width and current_resolution_height respectively represent the first width and the first height of the scene view at the first page resolution.

Based on the above equations (14) to (16), the initial hotspot data may be converted into target hotspot data that matches the current page resolution, thereby achieving page display adapted to different page resolutions.

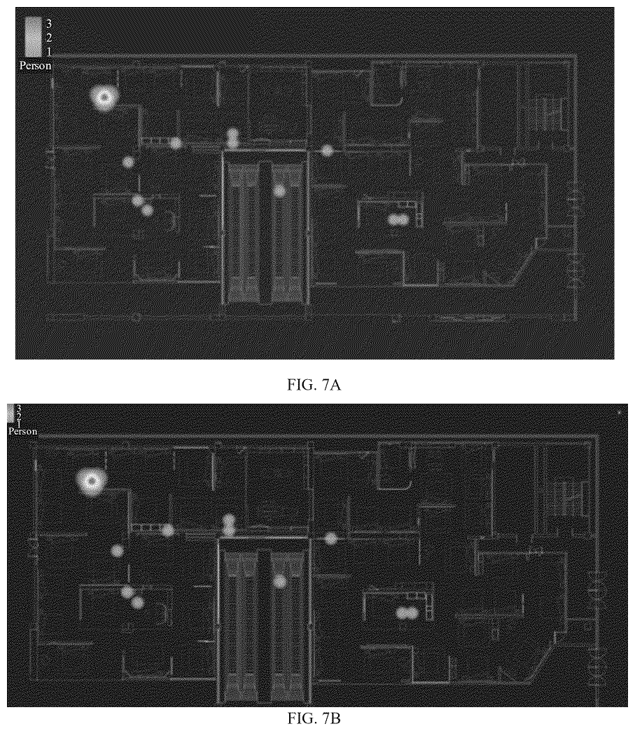

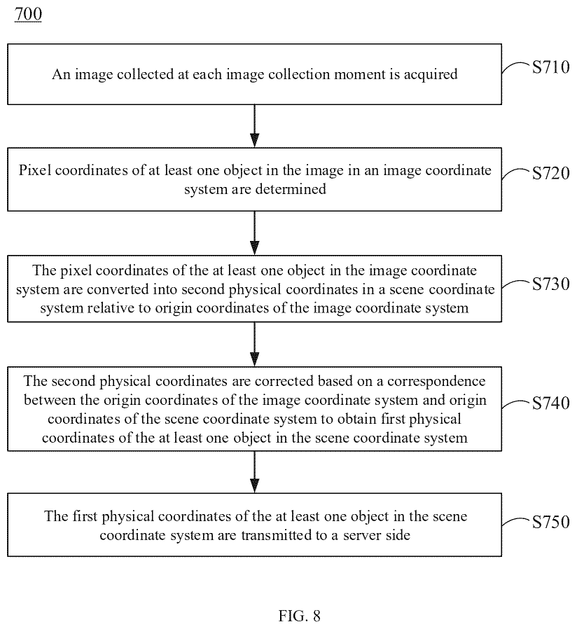

FIG. 7A and FIG. 7B are respectively effect diagrams of heat maps generated at different page resolutions.

FIG. 7A is a heat map generated at a page resolution of 854*480, and FIG. 7B is a heat map generated at a page resolution of 1916*1078. As shown in FIG. 7A and FIG. 7B, the heat map generated using the solutions of the present disclosure may be adapted to display on pages with different page resolutions. In addition, the heat map may clearly and intuitively show the degree of attention paid to each area in the scene by the object. The light spots shown in the figure represent objects. If the quantity of light spots in a certain area is relatively large, the color of the corresponding light spots will be darker, which indicates that the area is attracting more attention.

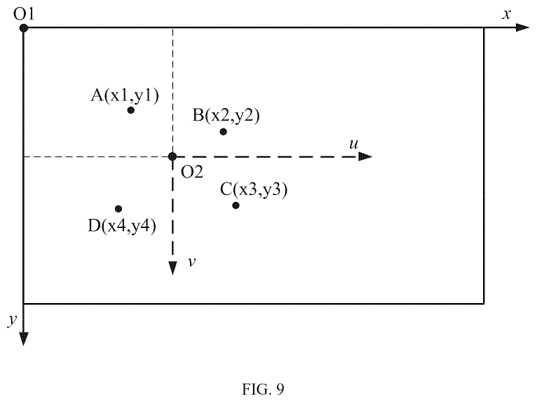

FIG. 8 is a flowchart of an image processing method according to the embodiments of the present disclosure.

As shown in FIG. 8, an image processing method 700 may include operations S710 to S750. In the embodiments of the present disclosure, the image processing method 700 may be executed by an image collection apparatus as an execution subject to execute related operations in the embodiments of the present disclosure.

In operation S710, an image collected at each image collection moment is acquired.

In operation S720, pixel coordinates of at least one object in the image in an image coordinate system are determined.

In operation S730, the pixel coordinates of the at least one object in the image coordinate system are converted into second physical coordinates in a scene coordinate system relative to origin coordinates of the image coordinate system.

In operation S740, the second physical coordinates are corrected based on a correspondence between the origin coordinates of the image coordinate system and origin coordinates of the scene coordinate system to obtain first physical coordinates of the at least one object in the scene coordinate system.

In operation S750, the first physical coordinates of the at least one object in the scene coordinate system are transmitted to a server side.

According to the embodiments of the present disclosure, the image collection apparatus may include a plurality of image collection devices. The plurality of image collection devices (such as cameras) are arranged at corresponding positions in the scene. The plurality of image collection devices may cover the area where the scene is located.

The image collection apparatus may acquire images collected by a plurality of image collection devices at each image collection moment. The image collection moment may be set according to actual conditions and is not limited here. After the images collected at each image collection moment are acquired, the image collection apparatus may determine pixel coordinates of at least one object in the image in the image coordinate system.

Afterwards, based on the correspondence between the image coordinate system and the scene coordinate system, the pixel coordinates of the at least one object in the image coordinate system are converted into second physical coordinates in the scene coordinate system relative to origin coordinates of the image coordinate system.

Next, based on the correspondence between the origin coordinates of the image coordinate system and the origin coordinates of the scene coordinate system, the second physical coordinates are corrected to obtain first physical coordinates of the at least one object in the scene coordinate system. It should be noted that the origin coordinates of the image coordinate system and the origin coordinates of the scene coordinate system may be the same point or different points, depending on the actual scene settings.

Then, the first physical coordinates of the at least one object in the scene coordinate system are transmitted to a server side (e.g., a cloud server), so that the server side generates initial hotspot data based on the first physical coordinates.

According to the embodiments of the present disclosure, the pixel coordinates of at least one object in the image are converted and corrected by using an image collection apparatus to obtain the first physical coordinates of each object in the scene coordinate system, and the first physical coordinates of each object in the scene coordinate system are transmitted to the server side. This is conducive to real-time image processing to obtain corresponding hotspot data, thereby facilitating fast acquisition of the density distribution of objects in the scene.

According to the embodiments of the present disclosure, the correspondence between the image coordinate system and the scene coordinate system may be determined in the following manner.

For example, four marking points may be determined in the image, and pixel coordinates of each of the four marking points in the image coordinate system as well as third physical coordinates of the four marking points relative to the origin coordinates of the image coordinate system may be acquired.

The pixel coordinates in the image coordinate system are converted to physical coordinates in the scene coordinate system (world coordinate system) using equation (17) below.

$$[ \begin{matrix}{x}_{w} \\ {y}_{w} \\ {z}_{w}\end{matrix} ] = [ \begin{matrix}{a}_{11} & {a}_{12} & {a}_{13} \\ {a}_{21} & {a}_{22} & {a}_{23} \\ {a}_{31} & {a}_{32} & 1\end{matrix} ] \cdot [ \begin{matrix}{x}_{im} \\ {y}_{im} \\ 1\end{matrix} ] \qquad ( 17 )$$

In equation (17), (x_{w}, y_{w}, z_{w}) represent the physical coordinates in the scene coordinate system, (xᵢₘ, yᵢₘ) represent the pixel coordinates in the image coordinate system converted from the physical coordinates (x_{w}, y_{w}, z_{w}),

$$[ \begin{matrix}{a}_{11} & {a}_{12} & {a}_{13} \\ {a}_{21} & {a}_{22} & {a}_{23} \\ {a}_{31} & {a}_{32} & 1\end{matrix} ]$$

represents the affine matrix, and a₁₁ to a₃₂ represent the parameters in the affine matrix. Here, it is assumed that the image plane is 1, the coordinates have only one scale factor, and therefore, zᵢₘ=1, a₃₃=1.

According to equation (17), the equations (18) to (20) below may be obtained.

$${x}_{w} = {a}_{11} * {x}_{im} + {a}_{12} * {y}_{im} + {a}_{13} \qquad ( 18 )$$

$${y}_{w} = {a}_{21} * {x}_{im} + {a}_{22} * {y}_{im} + {a}_{23} \qquad ( 19 )$$

$${z}_{w} = {a}_{31} * {x}_{im} + {a}_{32} * {y}_{im} + 1 \qquad ( 20 )$$

In order to obtain the physical coordinates (x_{world}, y_{world}) in the z_{w} plane, equation (21) below may be obtained by the projected triangle similarity method.

$${x}_{world} = \frac{{x}_{w}}{{z}_{w}} , {y}_{world} = \frac{{y}_{w}}{{z}_{w}} \qquad ( 21 )$$

According to equations (18) to (21), the physical coordinates (x_{world}, y_{world}) may be determined. x_{world} and y_{world} may be expressed as below.

$${x}_{world} = \frac{{a}_{11} * {x}_{im} + {a}_{12} * {y}_{im} + {a}_{13}}{{a}_{31} * {x}_{im} + {a}_{32} * {y}_{im} + 1} \qquad ( 22 )$$

$${y}_{world} = \frac{{a}_{21} * {x}_{im} + {a}_{22} * {y}_{im} + {a}_{23}}{{a}_{31} * {x}_{im} + {a}_{32} * {y}_{im} + 1} \qquad ( 23 )$$

The parameters a₁₁ to a₃₂ in the affine matrix may be determined according to the respective pixel coordinates of the above four marking points in the image coordinate system, the third physical coordinates of the four marking points relative to the origin coordinates of the image coordinate system, and equations (22) to (23).

The above parameters a₁₁ to a₃₂ may be determined using equation (24) below.

$$[ \begin{matrix}{x}_{1 im} & {y}_{1 im} & 1 & 0 & 0 & 0 & - {x}_{1 im} {x}_{1 w} & - {x}_{1 im} {y}_{1 w} & - {x}_{1 w} \\ 0 & 0 & 0 & {x}_{1 im} & {y}_{1 im} & 1 & - {y}_{1 w} {x}_{1 im} & - {y}_{1 im} {y}_{1 w} & - {y}_{1 w} \\ {x}_{2 im} & {y}_{2 im} & 1 & 0 & 0 & 0 & - {x}_{2 im} {x}_{2 w} & - {x}_{2 im} {y}_{2 w} & - {x}_{2 w} \\ 0 & 0 & 0 & {x}_{2 im} & {y}_{2 im} & 1 & - {y}_{2 w} {x}_{2 im} & - {y}_{2 im} {y}_{2 w} & - {y}_{2 w} \\ {x}_{3 im} & {y}_{3 im} & 1 & 0 & 0 & 0 & - {x}_{3 im} {x}_{3 w} & - {x}_{3 im} {y}_{3 w} & - {x}_{3 w} \\ 0 & 0 & 0 & {x}_{3 im} & {y}_{3 im} & 1 & - {y}_{3 w} {x}_{3 im} & - {y}_{3 im} {y}_{3 w} & - {y}_{3 w} \\ {x}_{4 im} & {y}_{4 im} & 1 & 0 & 0 & 0 & - {x}_{4 im} {x}_{4 w} & - {x}_{4 im} {y}_{4 w} & - {x}_{4 w} \\ 0 & 0 & 0 & {x}_{4 im} & {y}_{4 im} & 1 & - {y}_{4 w} {x}_{4 im} & - {y}_{4 im} {y}_{4 w} & - {y}_{4 w}\end{matrix} ] \cdot [ \begin{matrix}{a}_{11} \\ {a}_{12} \\ {a}_{13} \\ {a}_{21} \\ {a}_{22} \\ {a}_{23} \\ {a}_{31} \\ {a}_{32} \\ 1\end{matrix} ] = 0 \qquad ( 24 )$$

After the above parameters a₁₁ to a₃₂ are determined, the correspondence between the image coordinate system and the scene coordinate system may be determined according to equations (22) to (23). Based on this correspondence, i.e., equations (22) to (23), the pixel coordinates of at least one object in the image coordinate system may be converted into second physical coordinates in the scene coordinate system relative to the origin coordinates of the image coordinate system.

FIG. 9 schematically shows second physical coordinates of a plurality of objects in an image in a scene coordinate system relative to origin coordinates of an image coordinate system. The process of correcting the second physical coordinates will be described below with reference to FIG. 9.

FIG. 9 shows two coordinate systems, in which the coordinate system with the origin coordinates being point O1 is the scene coordinate system (xO1y), and the coordinate system with the origin coordinates being point O2 is the image coordinate system (uO2v). The origin coordinates O1 and the origin coordinates O2 may be the same point (i.e., O1 and O2 coincide with each other), or may be different points (i.e., O1 and O2 do not coincide with each other), which is not limited here. For ease of explanation, the following description is made by taking the case where the origin coordinates O1 and the origin coordinates O2 are different points as an example.

It is assumed that an image collected at each image collection moment includes 4 objects, for example, object A, object B, object C, and object D. Then, respective pixel coordinates of the 4 objects in the image coordinate system are determined. For example, the pixel coordinates corresponding to objects A to D are respectively A(x1im, y1im), B(x2im, y2im), C(x3im, y3im), and D(x4im, y4im).

Next, based on the above equations (22) to (23), the pixel coordinates of the 4 objects in the image coordinate system are converted into second physical coordinates in the scene coordinate system relative to the origin coordinates of the image coordinate system. As shown in FIG. 9, the second physical coordinates of object A relative to the origin coordinates O2 of the image coordinate system are (x1, y1), the second physical coordinates of object B relative to the origin coordinates O2 of the image coordinate system are (x2, y2), the second physical coordinates of object C relative to the origin coordinates O2 of the image coordinate system are (x3, y3), and the second physical coordinates of object D relative to the origin coordinates O2 of the image coordinate system are (x4, y4).

Since there is a coordinate error between the origin coordinates O2 of the image coordinate system and the origin coordinates O1 of the scene coordinate system, the second physical coordinates of each object need to be corrected, so as to convert the second physical coordinates into first physical coordinates relative to the origin coordinates O1 of the scene coordinate system.

For example, a coordinate correction value of the origin coordinates O2 of the image coordinate system relative to the origin coordinates O1 of the scene coordinate system in the scene coordinate system may be determined based on the correspondence between the origin coordinates O2 of the image coordinate system and the origin coordinates O1 of the scene coordinate system. For example, the above coordinate correction value may be determined according to the difference in the horizontal coordinate and the difference in the vertical coordinate between the origin coordinates O2 and the origin coordinates O1.

Afterwards, the second physical coordinates are corrected based on the coordinate correction value to obtain the first physical coordinates of the at least one object in the scene coordinate system.

For example, it is assumed that the coordinate correction value is (Δx, Δy). Taking object A as an example, the second physical coordinate (x1, y1) of object A may be corrected using equation (25) below to obtain the first physical coordinate (x1′, y1′) of object A in the scene coordinate system.

$$x {1}^{′} = x 1 + Δ x , y {1}^{′} = y 1 + Δ y \qquad ( 25 )$$

Similarly, based on the above method, the first physical coordinates of each of objects B to D in the scene coordinate system may be obtained.

According to the embodiments of the present disclosure, the second physical coordinates are corrected based on the correspondence between the origin coordinates of the image coordinate system and the origin coordinates of the scene coordinate system to obtain the first physical coordinates, thereby improving the accuracy of the first physical coordinates.

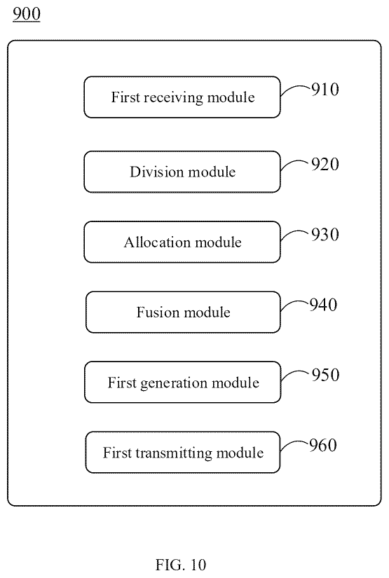

FIG. 10 is a block diagram of a data processing device according to the embodiments of the present disclosure.

As shown in FIG. 10, a data processing device 900 includes a first receiving module 910, a division module 920, an allocation module 930, a fusion module 940, a first generation module 950, and a first transmitting module 960.

The first receiving module 910 is used to receive first physical coordinates of at least one object in an image in a scene coordinate system from an image collection apparatus and receive calibration coordinates for a scene view from a terminal, in which the calibration coordinates represent a size of a view area corresponding to a scene in the scene view.

The division module 920 is used to divide the scene in the scene coordinate system to obtain a plurality of grids.

The allocation module 930 is used to, for each of the plurality of grids, respectively allocate the first physical coordinate of the at least one object to a corresponding grid based on the first physical coordinates of the at least one object in the scene coordinate system.

The fusion module 940 is used to perform fusion processing on the first physical coordinates of the object contained in each grid to obtain fused physical coordinates.

The first generation module 950 is used to generate initial hotspot data that is based on an image coordinate system according to the calibration coordinates for the scene view, an actual width and an actual height of the scene, and the fused physical coordinates.

The first transmitting module 960 is used to transmit the initial hotspot data to the terminal, so that the terminal generates a heat map within the scene based on the initial hotspot data.

According to the embodiments of the present disclosure, the first generation module 950 includes: a first conversion unit, a first determination unit and a second determination unit. The first conversion unit is used to convert the fused physical coordinates into initial fused pixel coordinates that is based on the image coordinate system according to the calibration coordinates for the scene view and the actual width and the actual height of the scene; the first determination unit is used to determine an initial display radius of the fused pixel coordinates according to the calibration coordinates for the scene view and the actual width and the actual height of the scene; and the second determination unit is used to determine the initial fused pixel coordinates and the initial display radius as the initial hotspot data.

According to the embodiments of the present disclosure, the first physical coordinates of the at least one object in the image in the scene coordinate system include first physical coordinates of objects contained in images respectively collected at a plurality of image collection moments in the scene coordinate system; and the allocation module 930 includes: a third determination unit and an allocation unit. The third determination unit is used to determine a quantity of the first physical coordinates of the objects contained in the images respectively collected at the plurality of image collection moments; and the allocation unit is used to, in response to determining that the quantity exceeds a preset threshold, allocate the first physical coordinates of the objects contained in the image collected at each image collection moment to corresponding grids to obtain the first physical coordinates of the object contained in each grid at each image collection moment.

According to the embodiments of the present disclosure, the fusion module 940 includes: a first fusion unit and a second fusion unit. The first fusion unit is used to perform the fusion processing on the first physical coordinates of the object contained in each grid at each image collection moment to obtain initial fused physical coordinates in each grid at each image collection moment; and the second fusion unit is used to perform a fusion on the initial fused physical coordinates in each grid at the plurality of image collection moments to obtain the fused physical coordinates.

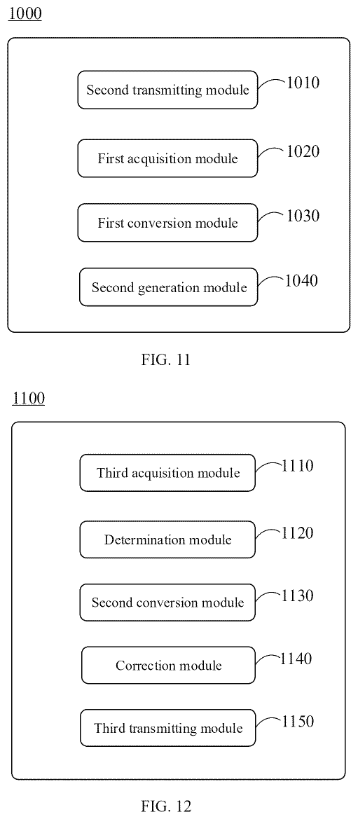

FIG. 11 is a block diagram of a heat map generation device according to the embodiments of the present disclosure.

As shown in FIG. 11, s heat map generation device 1000 includes: a second transmitting module 1010, a first acquisition module 1020, a first conversion module 1030, and a second generation module 1040.

The second transmitting module 1010 is used to transmit calibration coordinates for a scene view to a server side, where the calibration coordinates represent a size of a view area corresponding to a scene in the scene view.

The first acquisition module 1020 is used to, in response to receiving initial hotspot data from the server side, acquire a first height and a first width of the scene view at a first page resolution, and acquire an original height and an original width of the scene view at an original page resolution.

The first conversion module 1030 is used to convert the initial hotspot data into target hotspot data at the first page resolution based on the first height, the first width, the original height, and the original width.

The second generation module 1040 is used to generate a heat map within the scene based on the target hotspot data.

According to the embodiments of the present disclosure, the initial hotspot data includes initial fused pixel coordinates and an initial display radius; and the first conversion module 1030 includes: a fourth determination unit, a fifth determination unit, a second conversion unit, a third conversion unit, and a sixth determination unit. The fourth determination unit is used to determine a first width ratio based on the first width and the original width; the fifth determination unit is used to determine a first height ratio based on the first height and the original height; the second conversion unit is used to convert the initial fused pixel coordinates into the target pixel coordinates according to the first width ratio and the first height ratio; the third conversion unit is used to convert the initial display radius into a target display radius according to the first width ratio; and the sixth determination unit is used to determine the target hotspot data according to the target pixel coordinates and the target display radius.

According to the embodiments of the present disclosure, the heat map generation device 1000 further includes: a second acquisition module, a second receiving module, and a calibration module. The second acquisition module is used to acquire a second height and a second width of the scene view at a second page resolution; the second receiving module is used to receive configuration information for origin coordinates of the scene view; and the calibration module is used to calibrate a view area in the scene view using the second height, the second width, the original height and the original width based on the origin coordinates of the scene view to obtain calibration coordinates for the scene view.

According to the embodiments of the present disclosure, the calibration module includes: a receiving unit, a seventh determination unit, an eighth determination unit, and a ninth determination unit. The receiving unit is used to receive a calibration operation for the view area to determine calibration position information for the viewing area; the seventh determination unit is used to determine a second height ratio according to the second height and the original height; the eighth determination unit is used to determine a second width ratio according to the second width and the original width; and the ninth determination unit is used to determine the calibration coordinates based on the second height ratio, the second width ratio, and the calibration position information for the view area.

FIG. 12 is a block diagram of an image processing device according to the embodiments of the present disclosure.

As shown in FIG. 12, an image processing device 1100 includes: a third acquisition module 1110, a determination module 1120, a second conversion module 1130, a correction module 1140 and a third transmitting module 1150.

The third acquisition module 1110 is used to acquire an image collected at each image collection moment.

The determination module 1120 is used to determine pixel coordinates of at least one object in the image in an image coordinate system.

The second conversion module 1130 is used to convert the pixel coordinates of the at least one object in the image coordinate system into second physical coordinates in a scene coordinate system relative to origin coordinates of the image coordinate system.

The correction module 1140 is used to correct the second physical coordinates based on a correspondence between the origin coordinates of the image coordinate system and origin coordinates of the scene coordinate system to obtain first physical coordinates of the at least one object in the scene coordinate system.

The third transmitting module 1150 is used to transmit the first physical coordinates of the at least one object in the scene coordinate system to a server side.

According to the embodiments of the present disclosure, the correction module 1140 includes: a tenth determination unit and a correction unit. The tenth determination unit is used to determine a coordinate correction value of the origin coordinates of the image coordinate system relative to the origin coordinates of the scene coordinate system in the scene coordinate system based on the correspondence between the origin coordinates of the image coordinate system and the origin coordinates of the scene coordinate system; and the correction unit is used to correct the second physical coordinates based on the coordinate correction value to obtain the first physical coordinates of the at least one object in the scene coordinate system.

It should be noted that the implementations, technical problems solved, functions realized, and technical effects achieved of each module/unit/sub-unit in the device embodiments are the same or similar to the implementations, technical problems solved, functions realized, and technical effects achieved of each corresponding step in the method embodiments, and will not be repeated here.

In the technical solutions of the present disclosure, operations such as the collection, storage, use, processing, transmission, provision, disclosure and application of the data involved (for example, including but not limited to user personal information) all comply with the provisions of relevant laws and regulations and do not violate public order and good customs.

In the technical solutions of the present disclosure, authorization or consent from the data owner is obtained before relevant data is acquired or collected.

According to the embodiments of the present disclosure, the present disclosure also provides an electronic apparatus, a readable storage medium, and a computer program product.

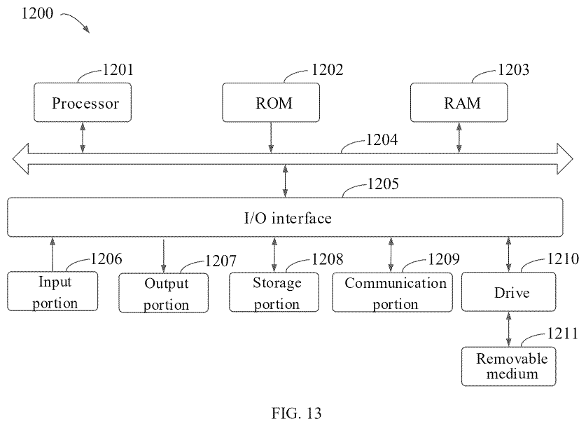

FIG. 13 schematically shows a block diagram of an electronic apparatus applicable for implementing the data processing method, the heat map generation method, and the image processing method according to the embodiments of the present disclosure.

As shown in FIG. 13, the electronic apparatus 1200 according to the embodiments of the present disclosure includes a processor 1201, which may execute various appropriate actions and processing according to a program stored in a read-only memory (ROM) 1202 or a program loaded from a storage portion 1208 to a random access memory (RAM) 1203. The processor 1201 may include, for example, a general-purpose microprocessor (e.g., a CPU), an instruction set processor and/or a related chipset and/or a dedicated microprocessor (e.g., an application-specific integrated circuit (ASIC)). The processor 1201 may also include an onboard memory for caching purposes. The processor 1201 may also include a single processing unit or a plurality of processing units for executing different actions of the method flow according to the embodiments of the present disclosure.

In the RAM 1203, various programs and data necessary for the operation of the electronic apparatus 1200 are stored. The processor 1201, the ROM 1202, and the RAM 1203 are connected to one another via a bus 1204. The processor 1201 executes various operations of the method flow according to the embodiment of the present disclosure by executing programs in the ROM 1202 and/or the RAM 1203. It should be noted that the programs may also be stored in one or more memories other than the ROM 1202 and the RAM 1203. The processor 1201 may also execute various operations of the method flow according to the embodiments of the present disclosure by executing programs stored in the one or more memories.

According to the embodiments of the present disclosure, the electronic apparatus 1200 may further include an input/output (I/O) interface 1205, which is also connected to the bus 1204. The electronic apparatus 1200 may also include one or more of the following components connected to the I/O interface 1205: an input portion 1206 including a keyboard, a mouse and the like; an output portion 1207 including a cathode ray tube (CRT), a liquid crystal display (LCD), a speaker and the like; a storage portion 1208 including a hard disk and the like; and a communication portion 1209 including a network interface card such as a LAN card, a modem and the like. The communication portion 1209 executes a communication processing via a network such as the Internet. A drive 1210 is also connected to the I/O interface 1205 as needed. A removable medium 1211, such as a magnetic disk, an optical disk, a magneto-optical disk, a semiconductor memory, or the like, is installed on the drive 1210 as needed, so that a computer program read therefrom is installed into the storage portion 1208 as needed.

The present disclosure also provides a computer-readable storage medium. The computer-readable storage medium may be included in the apparatus/device/system described in the above embodiments, or may exist independently without being assembled into the apparatus/device/system. The above computer-readable storage medium carries one or more programs, and when the one or more programs are executed, the method according to the embodiments of the present disclosure is implemented.

According to the embodiments of the present disclosure, the computer-readable storage medium may be a non-volatile computer-readable storage medium, for example, including but not limited to: a portable computer disk, a hard disk, a random access memory (RAM), a read-only memory (ROM), an erasable programmable read-only memory (EPROM or a flash memory), a portable compact disk read-only memory (CD-ROM), an optical storage device, a magnetic storage device, or any suitable combination of the above. In the present disclosure, a computer-readable storage medium may be any tangible medium containing or storing a program, and the program may be used by or in connection with an instruction execution system, a device, or a component. For example, according to the embodiments of the present disclosure, the computer-readable storage medium may include the ROM 1202 and/or the RAM 1203 described above and/or one or more memories other than the ROM 1202 and the RAM 1203.

The embodiments of the present disclosure also include a computer program product including a computer program. The computer program contains program codes for executing the method shown in the flowchart. When the computer program product runs in a computer system, the program codes are used to cause the computer system to implement the data processing method, the heat map generation method, and the image processing method provided by the embodiments of the present disclosure.

When executed by the processor 1201, the computer program executes the above functions defined in the system/device of the embodiments of the present disclosure. According to the embodiments of the present disclosure, the system, the device, the modules, the units, etc. described above may be implemented by computer program modules.

In one embodiment, the computer program may be stored in a tangible storage medium such as an optical storage device or a magnetic storage device. In another embodiment, the computer program may also be transmitted and distributed in the form of a signal on a network medium, and downloaded and installed through the communication portion 1209, and/or installed from the removable medium 1211. The program codes included in the computer program may be transmitted using any appropriate network medium, including but not limited to a wireless manner and a wired manner, or any appropriate combination of the above.

In such an embodiment, the computer program may be downloaded and installed from a network through the communication portion 1209, and/or installed from the removable medium 1211. When executed by the processor 1201, the computer program executes the above functions defined in the system of the embodiments of the present disclosure. According to the embodiments of the present disclosure, the system, the apparatus, the device, the modules, the units, etc. described above may be implemented by computer program modules.

According to the embodiments of the present disclosure, program code for executing the computer programs provided by the embodiments of the present disclosure may be written in any combination of one or more programming languages. Specifically, these computer programs may be implemented using high-level procedural and/or object-oriented programming languages, and/or assembly/machine languages. Programming languages include, but are not limited to, Java, C++, Python, “C” language or similar programming languages. The program codes may be executed entirely on a user's computing apparatus, partly on a use's computing apparatus, partly on a remote computing apparatus, or entirely on a remote computing apparatus or server. In a scenario where a remote computing apparatus is involved, the remote computing apparatus may be connected to the user computing apparatus via any type of network, including a local area network (LAN) or a wide area network (WAN), or may be connected to an external computing apparatus (for example, via the Internet using an Internet service provider).

The flowcharts and block diagrams in the accompanying drawings illustrate system architectures, functions, and operations that may be implemented by the system, the method, and the computer program product according to various embodiments of the present disclosure. In this regard, each box in the flowchart or block diagram may represent a module, a program segment, or a portion of a code. The module, the program segment, or the portion of a code contains one or more executable instructions for implementing the specified logical functions. It should also be noted that, in some alternative implementations, the functions noted in the blocks may occur in an order different from the order noted in the drawings. For example, two blocks shown in succession may, in fact, be executed substantially concurrently, or they may sometimes be executed in a reverse order, depending upon the functions involved. It should also be noted that each box in the block diagram or flowchart and combinations of boxes in the block diagram or flowchart may be implemented by a dedicated hardware-based system that executes the specified functions or operations, or may be implemented by a combination of dedicated hardware and computer instructions.

Those skilled in the art may understand that the features described in the various embodiments and/or claims of the present disclosure may be combined and/or cooperated in various manners, even if such combinations or cooperations are not explicitly described in the present disclosure. In particular, the features described in the various embodiments and/or claims of the present disclosure may be combined and/or cooperated in various manners without departing from the spirit and teachings of the present disclosure. All such combinations and/or cooperations fall within the scope of the present disclosure.

The embodiments of the present disclosure are described above. However, these embodiments are for illustrative purposes only and are not intended to limit the scope of the present disclosure. Although various embodiments are described above separately, this does not mean that measures in various embodiments may not be used advantageously in combination. The scope of the present disclosure is defined by the appended claims and the equivalents thereof. Without departing from the scope of the present disclosure, those skilled in the art may make various substitutions and modifications, and all these substitutions and modifications should fall within the scope of the present disclosure.

1. A data processing method, comprising:
receiving a first physical coordinate of at least one object in an image in a scene coordinate system from an image collection apparatus, and receiving a calibration coordinate for a scene view from a terminal, wherein the calibration coordinate represents a size of a view area corresponding to a scene in the scene view;
dividing the scene in the scene coordinate system to obtain a plurality of grids;
for each of the plurality of grids, allocating the first physical coordinate of the at least one object to a corresponding grid based on the first physical coordinate of the at least one object in the scene coordinate system;
performing fusion processing on the first physical coordinate of the object contained in each grid to obtain a fused physical coordinate;
generating initial hotspot data that is based on an image coordinate system according to the calibration coordinate for the scene view, an actual width and an actual height of the scene, and the fused physical coordinate; and
transmitting the initial hotspot data to the terminal, so that the terminal generates a heat map within the scene based on the initial hotspot data.

2. The method according to claim 1, wherein the generating initial hotspot data that is based on an image coordinate system according to the calibration coordinate for the scene view, an actual width and an actual height of the scene, and the fused physical coordinate comprises:
converting the fused physical coordinate into an initial fused pixel coordinate that is based on the image coordinate system according to the calibration coordinate for the scene view and the actual width and the actual height of the scene;
determining an initial display radius of the fused pixel coordinate according to the calibration coordinate for the scene view and the actual width and the actual height of the scene; and
determining the initial fused pixel coordinate and the initial display radius as the initial hotspot data.

3. The method according to claim 1, wherein the first physical coordinate of the at least one object in the image in the scene coordinate system comprises first physical coordinates of objects contained in images respectively collected at a plurality of image collection moments in the scene coordinate system; and
wherein the allocating the first physical coordinate of the at least one object to a corresponding grid based on the first physical coordinate of the at least one object in the scene coordinate system comprises:
determining a quantity of the first physical coordinates of the objects contained in the images respectively collected at the plurality of image collection moments; and
in response to determining that the quantity exceeds a preset threshold, allocating the first physical coordinates of the objects contained in the images collected at each image collection moment to corresponding grids, so as to obtain the first physical coordinates of the objects contained in each grid at each image collection moment.

4. The method according to claim 3, wherein the performing fusion processing on the first physical coordinate of the object contained in each grid to obtain a fused physical coordinate comprises:
performing fusion processing on the first physical coordinates of the objects contained in each grid at each image collection moment to obtain an initial fused physical coordinate in each grid at each image collection moment; and
performing fusion on the initial fused physical coordinates in each grid at the plurality of image collection moments to obtain the fused physical coordinate.

5. A heat map generation method, comprising:
transmitting a calibration coordinate for a scene view to a server side, wherein the calibration coordinate represents a size of a view area corresponding to a scene in the scene view;
in response to receiving initial hotspot data from the server side, acquiring a first height and a first width of the scene view at a first page resolution, and acquiring an original height and an original width of the scene view at an original page resolution;
converting the initial hotspot data into target hotspot data at the first page resolution based on the first height, the first width, the original height, and the original width; and
generating a heat map within the scene based on the target hotspot data.

6. The method according to claim 5, wherein the initial hotspot data comprises an initial fused pixel coordinate and an initial display radius; and the converting the initial hotspot data into target hotspot data at the first page resolution based on the first height, the first width, the original height, and the original width comprises:
determining a first width ratio based on the first width and the original width;
determining a first height ratio based on the first height and the original height;
converting the initial fused pixel coordinate into a target pixel coordinate according to the first width ratio and the first height ratio;
converting the initial display radius into a target display radius according to the first width ratio; and
determining the target hotspot data according to the target pixel coordinate and the target display radius.

7. The method according to claim 5, further comprising:
acquiring a second height and a second width of the scene view at a second page resolution;
receiving configuration information for an origin coordinate of the scene view; and
calibrating the view area in the scene view using the second height, the second width, the original height and the original width based on the origin coordinate of the scene view to obtain the calibration coordinate for the scene view.

8. The method according to claim 7, wherein the calibrating the view area in the scene view using the second height, the second width, the original height and the original width to obtain the calibration coordinate for the scene view comprises:
receiving a calibration operation for the view area to determine calibration position information for the view area;
determining a second height ratio according to the second height and the original height;
determining a second width ratio according to the second width and the original width; and
determining the calibration coordinate based on the second height ratio, the second width ratio, and the calibration position information for the view area.

9. An image processing method, comprising:
acquiring an image collected at each image collection moment;
determining a pixel coordinate of at least one object in the image in an image coordinate system;
converting the pixel coordinate of the at least one object in the image coordinate system into a second physical coordinate in a scene coordinate system relative to an origin coordinate of the image coordinate system;
correcting the second physical coordinate based on a correspondence between the origin coordinate of the image coordinate system and an origin coordinate of the scene coordinate system to obtain a first physical coordinate of the at least one object in the scene coordinate system; and
transmitting the first physical coordinate of the at least one object in the scene coordinate system to a server side.

10. The method according to claim 9, wherein the correcting the second physical coordinate based on a correspondence between the origin coordinate of the image coordinate system and an origin coordinate of the scene coordinate system to obtain a first physical coordinate of the at least one object in the scene coordinate system comprises:
determining a coordinate correction value of the origin coordinate of the image coordinate system relative to the origin coordinate of the scene coordinate system in the scene coordinate system based on the correspondence between the origin coordinate of the image coordinate system and the origin coordinate of the scene coordinate system; and
correcting the second physical coordinate based on the coordinate correction value to obtain the first physical coordinate of the at least one object in the scene coordinate system.

11-20. (canceled)

21. An electronic apparatus, comprising a memory and a processor, wherein the memory stores instructions executable by the processor, and when executed by the processor, the instructions are configured to cause the processor to execute the method according to claim 1.

22. A non-transitory computer-readable storage medium storing computer instructions, wherein the computer instructions are configured to cause a computer to execute the method according to claim 1.

23-26. (canceled)

27. An electronic apparatus, comprising a memory and a processor, wherein the memory stores instructions executable by the processor, and when executed by the processor, the instructions are configured to cause the processor to execute the method according to claim 5.

28. A non-transitory computer-readable storage medium storing computer instructions, wherein the computer instructions are configured to cause a computer to execute the method according to claim 5.

29. An electronic apparatus, comprising a memory and a processor, wherein the memory stores instructions executable by the processor, and when executed by the processor, the instructions are configured to cause the processor to execute the method according to claim 9.

30. A non-transitory computer-readable storage medium storing computer instructions, wherein the computer instructions are configured to cause a computer to execute the method according to claim 9.

31. The electronic apparatus according to claim 21, wherein the processor is further configured to:
convert the fused physical coordinate into an initial fused pixel coordinate that is based on the image coordinate system according to the calibration coordinate for the scene view and the actual width and the actual height of the scene;
determine an initial display radius of the fused pixel coordinate according to the calibration coordinate for the scene view and the actual width and the actual height of the scene; and
determine the initial fused pixel coordinate and the initial display radius as the initial hotspot data.

32. The electronic apparatus according to claim 21, wherein the first physical coordinate of the at least one object in the image in the scene coordinate system comprises first physical coordinates of objects contained in images respectively collected at a plurality of image collection moments in the scene coordinate system; and
wherein the processor is further configured to:
determine a quantity of the first physical coordinates of the objects contained in the images respectively collected at the plurality of image collection moments; and
in response to determining that the quantity exceeds a preset threshold, allocate the first physical coordinates of the objects contained in the images collected at each image collection moment to corresponding grids, so as to obtain the first physical coordinates of the objects contained in each grid at each image collection moment.

33. The electronic apparatus according to claim 32, wherein the processor is further configured to:
perform fusion processing on the first physical coordinates of the objects contained in each grid at each image collection moment to obtain an initial fused physical coordinate in each grid at each image collection moment; and
perform fusion on the initial fused physical coordinates in each grid at the plurality of image collection moments to obtain the fused physical coordinate.

34. The electronic apparatus according to claim 27, wherein the initial hotspot data comprises an initial fused pixel coordinate and an initial display radius; and
wherein the processor is further configured to:
determine a first width ratio based on the first width and the original width;
determine a first height ratio based on the first height and the original height;
convert the initial fused pixel coordinate into a target pixel coordinate according to the first width ratio and the first height ratio;
convert the initial display radius into a target display radius according to the first width ratio; and
determine the target hotspot data according to the target pixel coordinate and the target display radius.
